(19) United States
(12) Patent Application Publication
(10) Pub. No.: US 2026/0128437 A1
(43) Pub. Date: May 7, 2026

(54) POWER SUPPLY DEVICE

(71) Applicant: LEOTEK CORPORATION, Taipei City (TW)

(72) Inventor: Fu-Chin Chung, Taipei City (TW)

(21) Appl. No.: 19/006,281

(22) Filed: Dec. 31, 2024

(30) Foreign Application Priority Data
Nov. 6, 2024 (TW) 113142509

(51) Int. Cl. H01M 50/244; F21V 23/02; H01M 10/653; H01M 50/262; H01M 50/276

(52) U.S. Cl. CPC H01M 50/244; F21V 23/023; H01M 10/653; H01M 50/262; H01M 50/276

(57) ABSTRACT

A power supply device is provided. The power supply device comprises a housing body, a power supply module and a supporting frame. The housing body includes an upper cover and a base. The power supply module is disposed in the housing body and is in contact with the upper cover or the base. The supporting frame is detachably fixed to the housing body. The power supply module is held in the housing body through the supporting frame.

This application claims the benefits of the Taiwan application Serial No. 113142509 filed on Nov. 6, 2024, the disclosure of which is incorporated by reference herein in its entirety.

### TECHNICAL FIELD

The present invention relates to a power supply device, and in particular relates to a power supply device for outdoor lamps.

### BACKGROUND

The main heat source of current outdoor lamps comes from the power supply device, so the heat dissipation of the power supply device is extremely important. However, in order to meet the heat dissipation temperature specifications of high-temperature environments, the size of the lamp housing is often increased, which increases the cost and weight of the lamp, but also makes the position where the power supply device is configured less flexible. In view of this, how to meet the heat dissipation needs of the power supply device in the lamp while saving the area of the lamp housing is the development direction of those skilled in the art.

### SUMMARY

According to one aspect of the present invention, a power supply device is provided. The power supply device comprises a housing body, a power supply module and a supporting frame. The housing body includes an upper cover and a base. The power supply module is disposed in the housing body and is in contact with the upper cover or the base. The supporting frame is detachably fixed to the housing body. The power supply module is held in the housing body through the supporting frame.

According to another aspect of the present invention, a power supply device is provided. The power supply device comprises a housing body, a first power supply module, a second power supply module, a supporting frame and an extension frame. The housing body includes an upper cover and a base. The first power supply module is disposed in the housing body and is in contact with the base. The second power supply module is disposed in the housing body and being in contact with the upper cover. The supporting frame is detachably fixed to the housing body. The first power supply module is held in the housing body through the supporting frame. The extension frame is detachably fixed to the housing body. The second power supply module is disposed on the supporting frame and is held on the extension frame.

The above summary is not intended to represent all embodiments or all aspects of the present invention. Rather, the foregoing summary merely provides examples that illustrate the novel aspects and features of the present invention. The above and other aspects of the present invention will become better understood with regard to the following detailed description of the preferred but non-limiting embodiment(s). The following description is made with reference to the accompanying drawings.

### BRIEF DESCRIPTION OF THE DRAWINGS

The following figures are merely illustrative of embodiments and are not intended to limit the scope of embodiments or claims.

FIG. 1 is a stereogram of a power supply device according to an embodiment of the present invention.

FIG. 2 is a stereogram of a power supply device according to another embodiment of the present invention.

FIG. 3A to FIG. 3B are stereograms of a supporting frame of the power supply device.

FIG. 3C is a side view of the supporting frame of the power supply device according to an embodiment of the present invention.

FIG. 3D is a front view of the supporting frame of the power supply device according to an embodiment of the present invention.

FIG. 4 is a partial stereogram of a combination of the supporting frame and a power supply module of power supply device.

FIG. 5 is a stereogram of a power supply device according to another embodiment of the present invention.

FIG. 6 is a stereogram of a power supply device according to another embodiment of the present invention.

FIG. 7A to FIG. 7B are stereograms of a combination of a supporting frame and an extension frame of the power supply device.

FIG. 7C is a side view of a combination of the supporting frame and the extension frame of the power supply device.

FIG. 8 is a partial stereogram of a combination of the supporting frame, the extension frame and the power supply module of the power supply device.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the description of the specification, many specific details are provided to give the reader a more comprehensive understanding of the present invention; however, the present invention can still be practiced without some or all of these specific details. Additionally, well-known common steps or components are not described in detail to avoid unnecessarily limiting the present invention. The same or similar elements in the figures are represented by the same or similar sign. It should be noted that the figures are for illustrative purposes only and do not represent the actual size or quantity of the elements unless specifically stated otherwise.

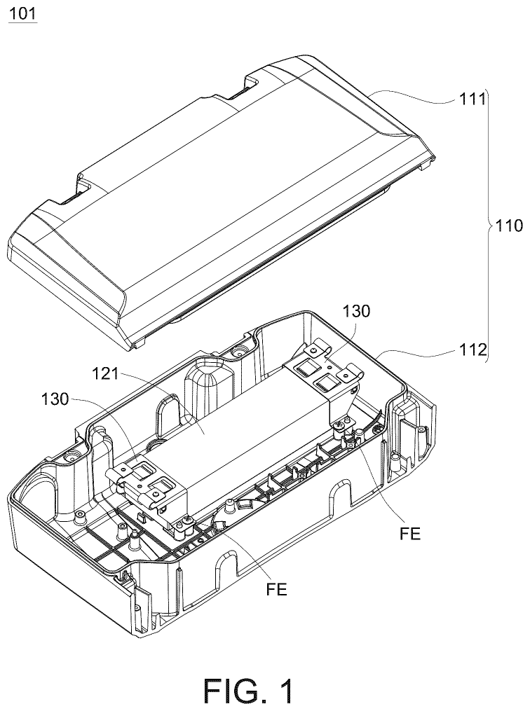

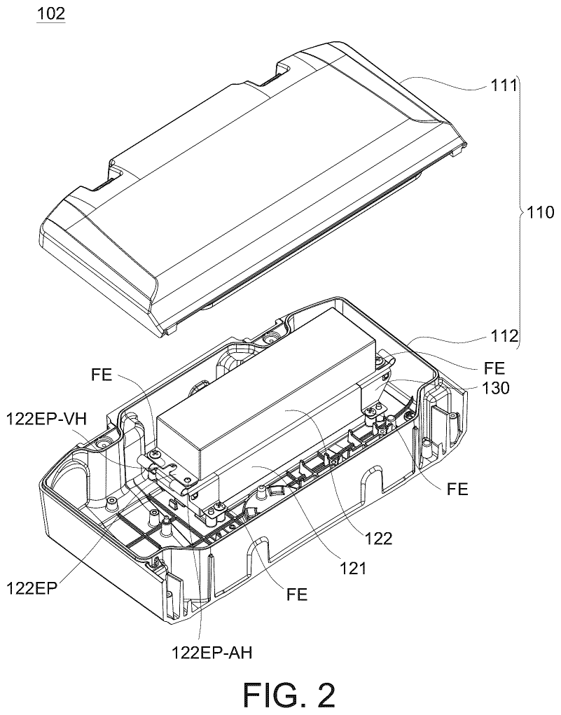

Please refer to FIGS. 1-2. FIG. 1 is a stereogram of a power supply device 101 according to an embodiment of the present invention. FIG. 2 is a stereogram of the power supply device 102 according to another embodiment of the present invention.

The power supply device 101, for example, is a power supply device for outdoor lamps. The power supply device 101 may comprise a housing body 110, a first power supply module 121 and a supporting frame 130. The housing body 110 may include an upper cover 111 and a base 112. The upper cover 111 and the base 112 may be made of, for example, aluminum, more specifically, aluminum alloy. In order to clearly illustrate the internal configuration of the power supply device 101, in FIG. 1, the upper cover 111 is suspended and slightly separated from the base 112. The upper cover 111 and the base 112 can be engaged. For example, the upper cover 111 is pivotally connected to the base 112 so that the upper cover 111 can be rotated and opened for maintenance or replacement of the first power supply module 121 or other portions in the base 112. The first power supply module 121 is disposed in the housing body 110 and is in contact with the base 112. By the contact between the first power supply module 121 and the base 112, the heat generated by the first power supply module 121 can be transferred to the housing body 110 through the heat conduction, so as to achieve heat dissipation. The supporting frame 130 is detachably fixed to the housing body 110, for example, detachably fixed to the base 112. As shown in FIG. 1, the power supply device 101 of this embodiment may, but not limited to, include two supporting frames 130, which is respectively disposed at the front and rear ends of the first power supply module 121. The first power supply module 121 may be fixed to the housing body 110 through the supporting frame 130.

The power supply device 102 is, for example, a power supply device for outdoor lamps. Due to the wattage requirements of outdoor lamps (for example, 240 W or more), two power supply modules are usually used. That is, the main difference between the power supply device 102 and the power supply device 101 is the number of power supply modules included. The power supply device 102 may comprise a housing body 110, a first power supply module 121, a second power supply module 122 and a supporting frame 130. The first power supply module 121 is disposed in the housing body 110 and is in contact with the base 112. The first power supply module 121 can be fixed to the housing body 110 through the supporting frame 130. The second power supply module 122 may be identical to the first power supply module 121. The second power supply module 122 is fixed to the supporting frame 130 and is located above the first power supply module 121. When the upper cover 111 is coupled with the base 112, the second power supply module 122 is in contact with the upper cover 111. By the contact between the second power supply module 122 and the upper cover 111, the heat generated by the second power supply module 122 can be transferred to the housing body 110 through the heat conduction, so as to achieve heat dissipation. In this embodiment, the power supply device 102 comprises two power supply modules. The first power supply module 121 and the second power supply module 122 are configured to be vertically stacked through a single supporting frame 130, thereby reducing the power supply. Therefore, the internal occupied space of the power supply device 102 can be reduced.

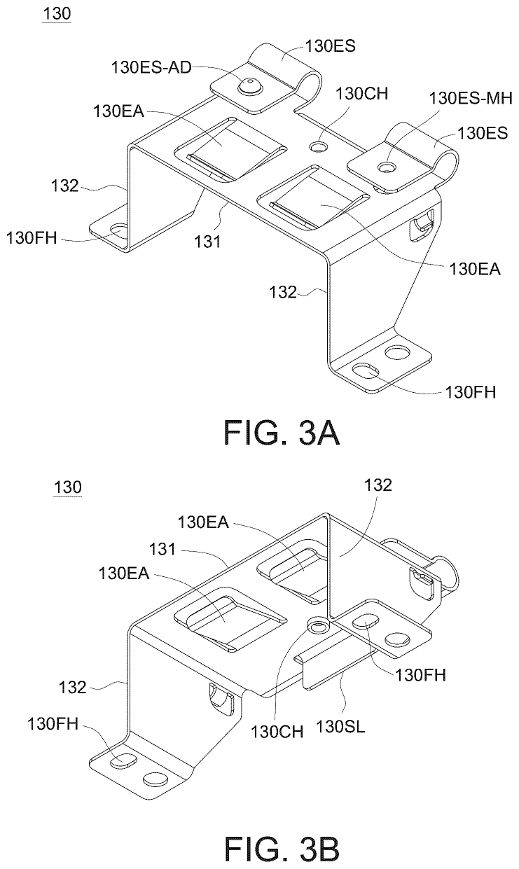

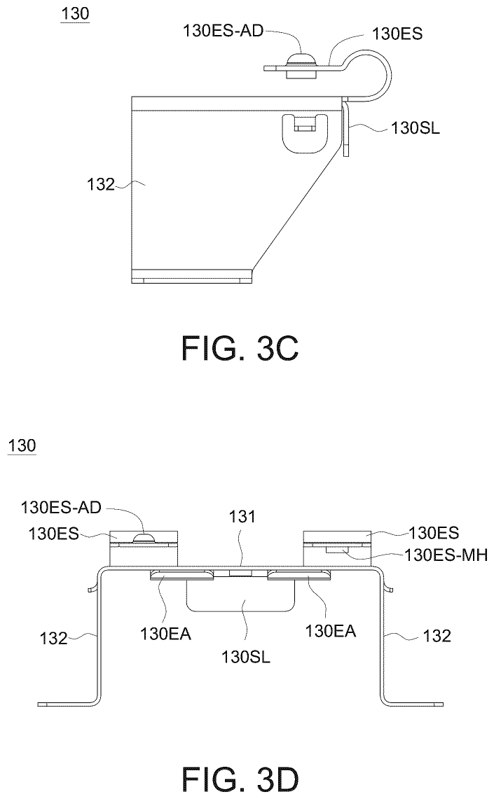

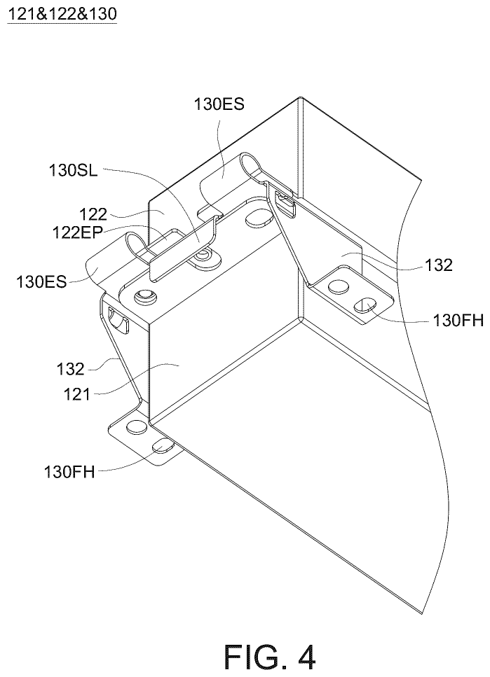

Please refer to FIGS. 3A-3D and FIG. 4. FIGS. 3A-3B are stereograms of the supporting frame 130. FIG. 3C is a side view of the supporting frame 130. FIG. 3D is a front view of the supporting frame 130. FIG. 4 is a partial stereogram of a combination of the supporting frame 130, the power supply module 121 and the power supply module 122.

The supporting frame 130 includes a middle plate structure 131 and two side plate structures 132 on both sides. The middle plate structure 131 and the two side plate structures 132 of the supporting frame 130 define a receiving space, so that the first power supply module 121 can be accommodated in this receiving space and located between the base 112 and the supporting frame 130, as shown in FIGS. 1-2. The supporting frame 130 may have an elastic pressing portion 130EA. The elastic pressing portion 130EA extends obliquely downward and is formed on the middle plate structure 131. In this embodiment, two (but not limited to) elastic pressing portions 130EA are included. When the first power supply module 121 is located between the base 112 and the supporting frame 130, the elastic pressing portion 130EA can press a top surface of the first power supply module 121 to provide downward force so that the contact between the first power supply module 121 and the base 112 can get closer, thereby increasing the heat dissipation effect of the heat conduction.

The supporting frame 130 may have fixing holes 130FH formed on the outside of each side plate structure 132. Referring back to FIGS. 1-2, the support frame 130 can be secured to the housing 110 through the fixing element FE being inserted into the fixing hole 130FH and the base 112. The fixing element FE is, for example but not limited to, a screw element. The supporting frame 130 may have a side limiting portion 130SL, which is formed on the middle plate structure 131 and extends straight downward. When the first power supply module 121 is located between the base 112 and the supporting frame 130, as shown in FIG. 4, the first power supply module 121 can abut against the side limiting portion 130SL, namely the first power supply module 121 can be limited by the side limiting portions 130SL at the front and rear ends and held in the housing body 110.

The supporting frame 130 may have elastic supporting portions 130ES. Each elastic supporting portion 130ES is a folded elastic piece structure formed on the middle plate structure 131. In this embodiment, two (but not limited to) elastic supporting portions 130ES are included. The second power supply module 122 is fixed on the elastic supporting portions 130ES. Referring back to FIG. 2, the second power supply module 122 may have extension plate portions 122EP at the front and rear ends. The extension plate portion 122EP covers the elastic supporting portions 130ES, and has a through hole 122VH. Each elastic supporting portion 130ES has a mounting hole 130MH. The second power supply module 122 may be fixed to the elastic supporting portions 130ES through a fixing element FE being inserted into the through hole 122VH and the mounting hole 130MH. In addition, the extension plate portion 122EP may have an alignment hole 122AH, and one of the elastic supporting portions 130ES may have an alignment protrusion 130AD. The second power supply module 122 and the elastic supporting portions 130ES can be positioned with each other through the alignment protrusion 130AD passing through the alignment hole 122AH, so that the second power supply module 122 may be installed more quickly. When the upper cover 111 is engaged with the base 112, the upper cover 111 is in contact with and presses downward the second power supply module 122. At this time, the elastic supporting portions 130ES are also deformed to provide a pre-pressure resilience, so that the second power supply module 122 is pressed downwardly. The contact between the supply module 122 and the upper cover 111 can get closer, thereby increasing the heat dissipation effect of the heat conduction.

It should be noted that when the power supply device is provided with only a single power supply module, the single power supply module can be selectively disposed in the receiving space defined by the supporting frame 130 to be in contact with the base 112 (i.e. the aforementioned implementation of only the first power supply module 121), or a single power supply module is fixed on the supporting frame 130 to be in contact with the upper cover 111. That is, the arrangement of a single power supply module can be divided into two methods: being in contact with the upper cover 111 or being in contact with the base 112.

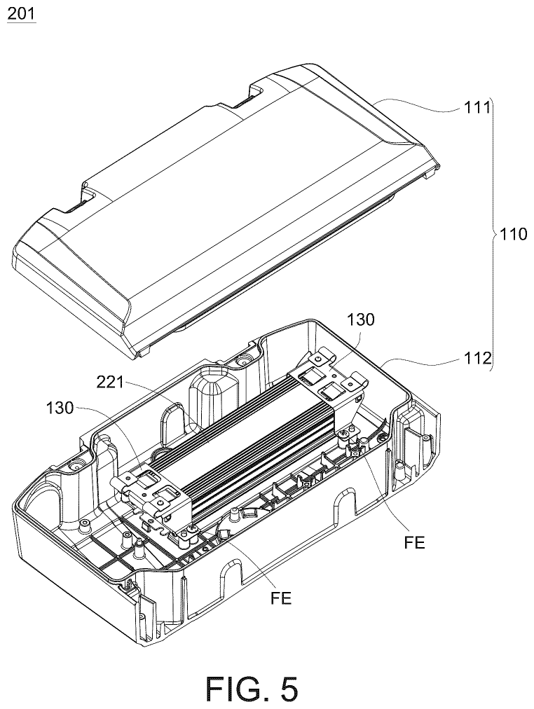

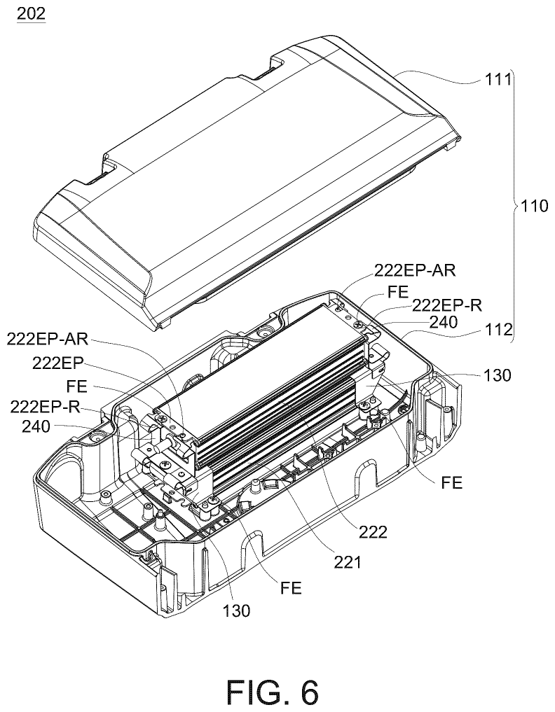

Please refer to FIGS. 5-6. FIG. 5 is a stereogram of a power supply device 201 according to another embodiment of the present invention. FIG. 6 is a stereogram of a power supply device 202 according to yet another embodiment of the present invention.

The power supply device 201 is, for example, a power supply device for outdoor lamps. The power supply device 201 may include a housing 110, a first power supply module 221 and a supporting frame 130. In the present invention, the first power supply module 221 and the aforementioned first power supply module 121 are power supply modules of different specifications, but both can be fixed by using the same supporting frame 130. The first power supply module 221 is disposed in the housing 110 and is in contact with the base 112. The first power supply module 221 is held in the housing 110 through the supporting frame 130. By the contact between the first power supply module 221 and the base 112, the heat generated by the first power supply module 221 can be transferred to the housing 110 through the heat conduction for heat dissipation. In addition, the implementation details regarding the housing 110 and the supporting frame 130 are the same as those described above, and will not be described again.

The power supply device 202 is, for example, a power supply device for outdoor lamps. Due to the wattage requirements of outdoor lamps (for example, 240 W or more), two power supply modules are usually used. That is, the main difference between the power supply device 202 and the power supply device 201 is the number of power supply modules included. The power supply device 202 may comprise a housing body 110, a first power supply module 221, a second power supply module 222, a supporting frame 130 and an extension frame 240. The first power supply module 221 is disposed in the housing body 110 and is in contact with the base 112. The first power supply module 221 can be fixed to the housing body 110 through the supporting frame 130. The second power supply module 222 is disposed in the housing body 110 and is in contact with the upper cover 111. The extension frame 240 is detachably fixed to the supporting frame 130. The second power supply module 222 is disposed on the supporting frame 130 and is held on the extension frame 240, so that the second power supply module 222 is located above the first power supply module 221. By the contact between the second power supply module 222 and the upper cover 111, the heat generated by the second power supply module 222 located above can be transferred to the housing 110 through the heat conduction for heat dissipation. In this embodiment, the power supply device 202 includes two power supply modules. The difference from the aforementioned power supply device 102 is that the first power supply module 221 and the second power supply module 222 are configured to be vertically stacked through the detachable supporting frame 130 and the extension frame 240. Therefore, the internal occupied space of the power supply device 202 can be reduced.

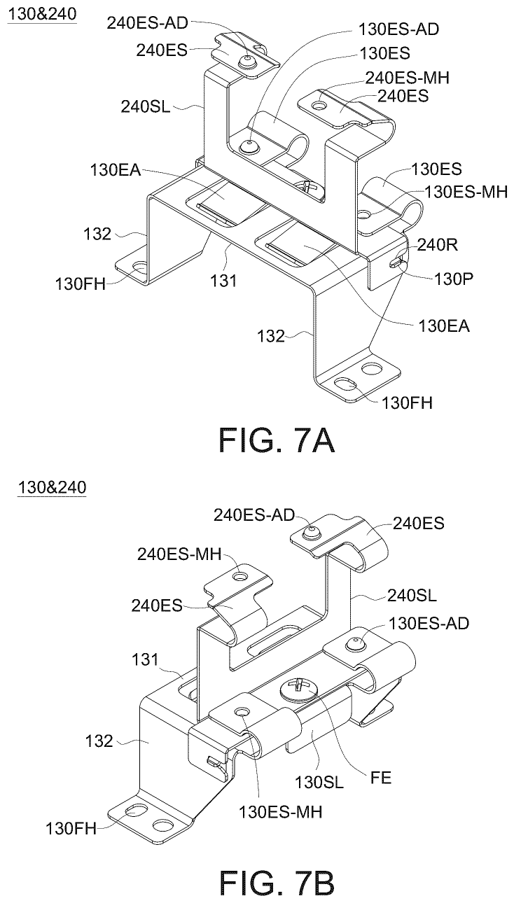

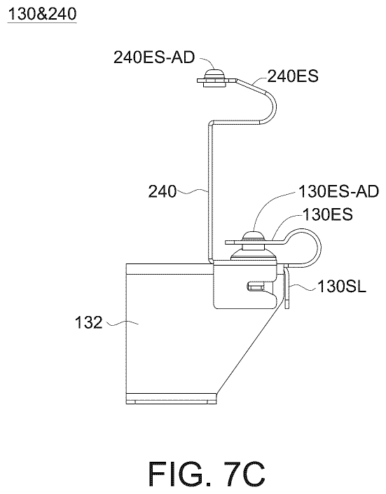

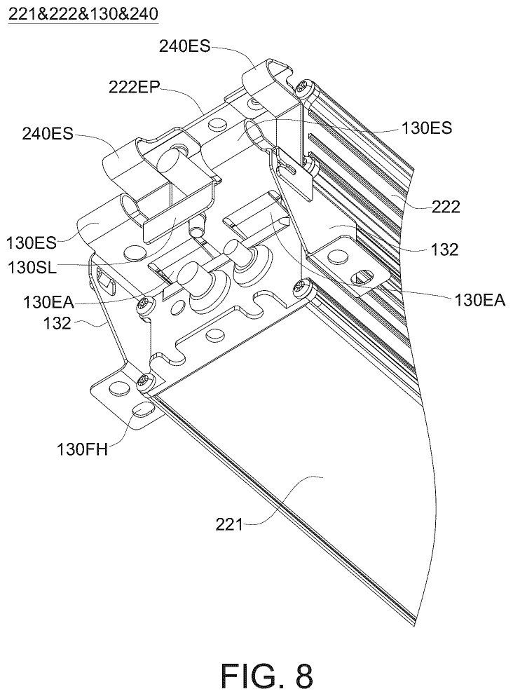

Please refer to FIGS. 7A-7C and FIG. 8, FIGS. 7A-7B are stereograms of a combination of the supporting frame 130 and the extension frame 240. FIG. 7C is a combination of the supporting frame 130 and the extension frame 240 of the power supply device. FIG. 8 is a partial stereogram of a combination of the supporting frame 130, the extension frame 240, the first power supply module 221 and the second power supply module 222.

Based on the different specifications of the power supply modules, the sizes of the power supply modules are also different. The first power supply module 221 and the second power supply module 222 are shorter than the first power supply module 121 and the second power supply module 122, so the second power supply module 222 that needs to be installed above may not be suitable for the fixed position of the supporting frame 130. Therefore, according to the specifications of the first power supply module 221 and the second power supply module 222, the extension frame 240 needs to be added to be combined with the supporting frame 130 to provide a position for the second power supply module 222 to be fixed.

The supporting frame 130 may have a protrusion portion 130P, and the protrusion portion 130P is formed on each side plate structure 132 to protrude outward. The extension frame 240 may have a guide rail portion 240R corresponding to the protrusion portion 130P, and the guide rail portion 240R is a recess structure. The supporting frame 130 and the extension frame 240 can slide into the guide rail portion 240R through the protrusion portion 130P to position each other. Next, the supporting frame 130 may have a combination hole 130CH (see FIGS. 3A-3B), and the extension frame 240 may have a combination hole (not shown) aligned with the combination hole 130CH. As shown in FIG. 7B, the supporting frame 130 and the extension frame 240 can be fixed to each other through the fixing element FE being inserted into their respective combination holes. Thus, the assembly of the supporting frame 130 and the extension frame 240 can be completed.

The extension frame 240 may have a side limiting portion 240SL. The side limiting portion 240SL is a U-shaped plate structure. When the second power supply module 222 is fixed to the extension frame 240, the second power supply module 222 abuts the side limiting portion 240SL to limit the position. The extension frame 240 may have an elastic supporting portion 240ES. The elastic supporting portion 240ES is a folded elastic piece structure formed at the end of the side limiting portion 240SL. The second power supply module 222 can be fixed on the elastic supporting portion 240ES. In detail, as shown in FIG. 6, the second power supply module 222 may have an extension plate portion 222EP covering the elastic supporting portion 240ES, and the extension plate portion 222EP has a recess 222R. The elastic supporting portion 240ES has a mounting hole 240MH. The second power supply module 222 can be fixed to the elastic supporting portion 240ES through the fixing element FE being inserted into the recess 222R and the mounting hole 240MH. In addition, the extension plate portion 222EP may have an alignment recess 222AR, and the elastic supporting portion 240ES may have an alignment protrusion 240AD. The second power supply module 222 and the elastic supporting portion 240ES are inserted into the alignment recess 222AR through the alignment protrusions 240AD to position each other, so that the second power supply module 222 can be installed more quickly. When the upper cover 111 is engaged with the base 112, the upper cover 111 is in contact with and presses downward the second power supply module 222. At this time, the elastic supporting portion 240ES is also deformed to provide a pre-pressure rebound force, so that the second power supply module 222 is pressed downwardly. The contact between the supply module 222 and the upper cover 111 gets closer, thereby increasing the heat dissipation effect of the heat conduction.

It should be noted that when the power supply device is only provided with a single power supply module, the single power supply module can be selectively disposed in the receiving space defined by the supporting frame 130 to be in contact with the base 112 (i.e., the aforementioned implementation which only the first power supply module 221 is used in), or a single power supply module is fixed to the extension frame 240 and disposed on the supporting frame 130 to be in contact with the upper cover 111. That is, the arrangement of a single power supply module can be divided into two methods: being in contact with the upper cover 111 or being in contact with the base 112.

According to the above description, the present invention provides a novel power supply device, which can achieve the configuration of a single power supply module or the configuration of multiple power supply modules through a supporting frame and even an extension frame that is able to be assembled with the supporting frame. In the configuration of a single power supply module, being in contact with the upper cover or base of the housing can be flexibly chosen to increase heat dissipation area. Regarding the configuration of multiple power supply modules, these power supply modules can respectively be in contact with the upper cover and the base to increase heat dissipation area. Furthermore, through the arrangement of the elastic supporting portion of the supporting frame or the extension frame, a pre-pressure rebound force can be provided to make the contact between the power supply module and the upper cover closer, thereby increasing the heat dissipation effect of the heat conduction. Thereby, the present invention can further increase the internal configuration cost of the power supply device and effectively dissipate heat.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A power supply device, comprising:
a housing body, including an upper cover and a base;
a power supply module, disposed in the housing body and being in contact with the upper cover or the base; and
a supporting frame, detachably fixed to the housing body, wherein the power supply module is held in the housing body through the supporting frame.

2. The power supply device of claim 1, wherein the power supply module is in contact with the base, the power supply module is accommodated in a receiving space defined by the supporting frame and is located between the base and the supporting frame, the supporting frame has an elastic pressing portion, and the elastic pressing portion props against a top surface of the power supply module.

3. The power supply device of claim 1, wherein the power supply module is in contact with the base, the power supply module is accommodated in a receiving space defined by the supporting frame and is located between the base and the supporting frame, the supporting frame has a side limiting portion, and the power supply module props against the side limiting portion.

4. The power supply device of claim 1, wherein the supporting frame has a fixing hole, and the supporting frame is fixed to the housing body through a fastening element being inserted into the fixing hole and the base.

5. The power supply device of claim 1, wherein the number of power supply modules is plural, a first power supply module and a second power supply module are included, the first power supply module is accommodated in a receiving space defined by the supporting frame and is located between the base and the supporting frame, the second power supply module is fixed to the supporting frame and is located above the first power supply module, the first power supply module is in contact with the base, and the second power supply module is in contact with the upper cover.

6. The power supply device of claim 5, wherein the extension frame has an elastic supporting portion, and the second power supply module is fixed to the elastic supporting portion.

7. The power supply device of claim 6, wherein the second power supply module has an extension plate portion, the extension plate portion covers the elastic supporting portion, the extension plate portion has a via hole, the elastic supporting portion has a mounting hole, and the second power supply module is fixed to the elastic supporting portion through a fastening element being inserted into the via hole and the mounting hole.

8. The power supply device of claim 7, wherein the extension plate portion has an alignment hole, the elastic supporting portion has an alignment protrusion, and the second power supply module and the elastic supporting portion snap into the alignment recess through the alignment protrusion to position each other.

9. A power supply device, comprising:
a housing body, including an upper cover and a base;
a first power supply module, disposed in the housing body and being in contact with the base;
a second power supply module, disposed in the housing body and being in contact with the upper cover;
a supporting frame, detachably fixed to the housing body, wherein the first power supply module is held in the housing body through the supporting frame; and
an extension frame, detachably fixed to the housing body, wherein the second power supply module is disposed on the supporting frame and is held in the extension frame.

10. The power supply device of claim 9, wherein the supporting frame has a protrusion portion, the extension frame has a guide rail portion, the guide rail portion is a recess structure, and the supporting frame and the extension frame slide into the guide rail portion through the protrusion portion to position each other.

11. The power supply device of claim 9, wherein the supporting frame and the extension frame each has a combination hole, and the supporting frame and the extension frame are fixed to each other through a fixing element being inserted into the two combination holes.

12. The power supply device of claim 9, wherein the supporting frame has a side limiting portion, and the second power supply module props against the side limiting portion.

13. The power supply device of claim 12, wherein the extension frame has an elastic supporting portion, the elastic supporting portion is a folded elastic piece structure formed at an end of the side limiting portion, and the second power supply module is fixed to the elastic supporting portion.

14. The power supply device of claim 13, wherein the second power supply module has an extension plate portion, the extension plate portion covers the elastic supporting portion, the extension plate portion has a recess, the elastic supporting portion has a mounting hole, and the second power supply module is fixed to the elastic supporting portion through a fastening element being inserted into the recess and the mounting hole.

15. The power supply device of claim 14, wherein the extension plate portion has an alignment recess, the elastic supporting portion has an alignment protrusion, and the second power supply module and the elastic supporting portion snap into the alignment recess through the alignment protrusion to position each other.

16. The power supply device of claim 1, wherein the supporting frame includes a middle plate structure and two side plate structures, the two side plate structures are located on both sides of the middle plate structure, and the middle plate structure and the two side plate structures define a receiving space.

17. The power supply device of claim 9, wherein the supporting frame includes a middle plate structure and two side plate structures, the two side plate structures are located on both sides of the middle plate structure, and the middle plate structure and the two side plate structures define a receiving space.

18. The power supply device of claim 16, wherein the supporting frame has an elastic pressing portion, and the elastic pressing portion extends obliquely downward and is formed in the middle plate structure.

19. The power supply device of claim 16, wherein the supporting frame has a side limiting portion, and the side limiting portion extends straight downward and is formed in the middle plate structure.
